(19) United States
(12) Patent Application Publication
(10) Pub. No.: US 2007/0130002 A1
(43) Pub. Date: Jun. 7, 2007

(54) System and method for delivery pay for performance advertising with enhanced effectiveness

(75) Inventors: John Arthur Moran, Fort Myers, FL (US); Robert Llewellyn Protheroe, Naples, FL (US)

Correspondence Address: TIMOTHY P. O'HAGAN, 8710 KILKENNY CT, FORT MYERS, FL, 33912, US

(73) Assignee: MIVA, Inc., Fort Myers, FL (US)

(21) Appl. No.: 11/284,571

(22) Filed: Nov. 22, 2005

(51) Int. Cl. G06Q 30/00

(52) U.S. Cl. 705/14

(57) ABSTRACT

An advertising system provides content relevant advertisements to a client. The system comprises an advertisement object, an auto rendering object, and a distribution object. The advertisement object defined an instance of advertisement content in a placement database and defined, in association with the instance, each of a financial parameter and redirect data. The auto rendering object generates associated advertisement content. The associated advertisement content being associated advertisement content selected from a group of associated advertisement content consisting of: i) an alternative rendering of the instance of advertisement content; and ii) an alternative rendering of content obtained in response to linking to the redirect URL. The distribution object receives advertisement requests and, in response to receiving an advertisement request: i) obtains from the placement database, an instance of advertisement content; ii) obtains from the placement database, the associated advertisement content that is associated with the instance of advertisement content in the placement database, and iii) returns an advertisement impression comprising both the instance of advertisement content and the associated advertisement content.

### TECHNICAL FIELD

The present invention relates to a system and method for providing content relevant pay for performance advertising in conjunction with media content such a web page or email and, more particularly to a method for providing auto rendered associated advertisement content in association with pay for performance advertisement content to enhance the effectiveness of the an advertisement impression.

### BACKGROUND OF THE INVENTION

Placement of content relevant advertising in web published media content has existed for several years. The most simple method for placement of advertising within web published media is for the publisher to simply hard code an advertiser provided banner advertisement within the HTML web page.

When a client system establishes and HTTP session to the publisher's web server, the returned web page includes both the content and the embedded banner advertisement. The banner advertisement may include an active link to the advertiser's landing page which, if clicked by the viewer, will cause the client to be directed to the advertiser's landing page.

A challenge with such a solution is that the hard coded banner advertisement is relatively permanent. The entire web page must be changed to change the contents of the banner advertisement.

An alternative system is disclosed in US Published Application 2004/0093327 to Anderson et al. Anderson et al. discloses a system wherein the web published media includes a “space” for an advertisement and, upon a client making a content request to the publisher's web server, the web server makes an advertisement request to an advertising system. The advertising system, which has analyzed the content of the published media, selects an advertisement relevant to the published media and returns the advertisement to the web server for placement within the space available within the web published media. The webpage that includes the dynamically placed advertisement embedded therein is returned to the client making the request.

Again, the advertisement may include an active link to the advertiser's landing page which, if clicked by the viewer, will cause the client to be directed to the advertiser's landing page.

It has also been proposed to include content relevant advertisements in distributed media content such as HTML email messages. In one example, US Published Application 2005/0076051 to Carobus et al. describes a system for serving content targeted ads in email.

The Carobus et al. system provides an HTML snippet for inclusion in each email sent by the publisher. The HTML snippet includes a URL to which an impression request can be made and which is uniquely associated with the content that was previously made available to the Carobus et al. system.

When a client email system opens the email, an impression request is made to a URL identified in the HTML snippet. In response to the impression request, the Carobus et al. system: i) looks up previously registered content; ii) builds and returns an advertisement image including one or more relevant advertisements; and iii) assigns and returns a unique session ID. The session ID is returned as a cookie.

When a user “clicks” a rectangular region, the cookie, including the unique session ID, is returned to the server to allow the server to return a redirect URL to a landing page associated with the selected advertisement.

In an alternative system described in U.S. patent application Ser. No. 11/236,460, filed on Sep. 27, 2005 and commonly assigned with the present patent application, the email includes an image map of predetermined parameters, a template identifier identifying the image map and/or its predetermined parameters, a predetermined content request URL, and a unique instance identifier.

When a client email system opens the email, an impression request is made to the predetermined content request URL. The impression request includes the predetermined mail identifier and the template identifier.

In response, the system looks up the parameters associated with the template identifier, builds and returns and advertisement image including one or more relevant advertisements sized to correspond to the image map, and stores an association between the unique ID provided in the request and redirect data associated with the advertiser.

When a user “clicks” on a region of the image map (e.g. one of the advertisements), a connection is made to redirect request URL embedded in the image map. The redirect request includes the unique ID (the same one as previously provided in the content request) to allow the server to return a redirect URL to a landing page associated with the selected advertisement.

While each of the above described systems is useful for placement of advertisements within interactive content, a drawback is that the effectiveness of the advertisement remains limited to the effectiveness of the advertisement content provided by the advertiser.

What is needed is a system and method for providing advertisements in conjunction with inline search results or published or distributed media content, such as a web page or email, that do not suffer the disadvantages of known systems. In one aspect, what is needed is a system and method for providing content relevant advertisement with an enhanced effectiveness. In a further aspect, what is needed is a system and method for providing content relevant advertisement with auto-rendered associated advertisement content in combination with advertiser provided advertisement content to enhance the effectiveness of the advertisement impression.

### SUMMARY OF THE INVENTION

A first aspect of the present invention comprises an advertisement system for providing enhanced content relevant instances of advertisement content for rendering in association with affiliate content—such as media content and/or inline search results content.

The system comprises an advertisement object, an auto rendering object, and a distribution object. The advertisement object defines, in a placement database, an instance of advertisement content. The advertisement object further defines, in association with the instance of advertisement content: i) a financial parameter; and ii) redirect data. The redirect data is data useful for determining a redirect URL to which a client system is to be directed upon user response to the advertisement content or associated advertisement content.

The auto rendering object generates the associated advertisement content. The associated advertisement content is associated advertisement content selected from a group of associated advertising comprising of: i) an alternative rendering of the instance of advertisement content; and ii) an alternative rendering of content obtained in response to linking to the redirect URL.

The distribution object receives content requests and, in response to receiving a content request: i) obtains, from the placement database, an instance of advertisement content associated with the media content; ii) obtains, from the placement database, the associated advertisement content related to the instance of advertisement content, and iii) returns an advertisement impression comprising both the instance of advertisement content and the associated advertisement content.

In one sub embodiment, the associated advertisement content may be an audio rendering of a portion of the advertisement content. In such sub embodiment, the auto rendering object includes a text to speech rendering object which, in response to input of a text string renders a spoken representation of the text string as an audio file.

The text to speech rendering object may include a database of pronunciation instructions for a plurality of words known as a database of known good words. The object renders a spoken representation of each word in the text string for which the pronunciation instructions are available in the database of known good words. The object prompts user entry of a pronunciation instruction for each word within the text string for which a pronunciation instruction is not available in the data base of known good words.

Further, if the audio file matches review rules indicating that review is required, the auto rendering object may prompt user review of an audio file before defining the audio file in the placement database—as associated advertisement content related to an instance of advertisement content.

In another sub embodiment, the associated advertisement content may be a preview image comprising at least a portion of content of a web page obtained in response to linking to the redirect URL In such sub embodiment, the auto rendering object includes a preview image rendering object which: i) captures content from a web page obtained in response to linking to the redirect URL; ii) renders such captured content as a preview image file; and iii) defines the preview image file in the placement database—as associated advertisement content related to an instance of advertisement content.

The preview image rendering object may capture content from the web page by capturing an image of a rendering of the web page including: i) determining whether redirects are received in response to establishing a connection to the URL to which the client is directed upon user responding to the advertisement; ii) establishing a connection to the redirect to a redirect web page and capturing an image of a rendering of the redirect web page.

The preview image rendering object may capture content from the web page by capturing an image of a rendering of the web page including: i) determining whether the web page includes a display of dynamic content; and ii) capturing an image of a rendering of the web page after initiating a delay to enable the dynamic content to stabilize.

Further, if the preview matches review rules indicating that review is required, the auto rendering object may prompt user review of a preview image file before defining the preview image file in the placement database—as associated advertisement content related to an instance of advertisement content.

In a third sub embodiment, the associated advertisement content may be a motion video rendering of a portion of the advertisement content. In such sub embodiment, the auto rendering object includes a text to motion video rendering object in response to input of a text string portion of the instance of advertisement content, renders motion video of a character speaking the text string as a compressed video file.

The text to motion video rendering object may include a database of pronunciation instructions for a plurality of words known as a database of known good words. The object renders a spoken representation of each word in the text string for which the pronunciation instructions are available in the database of known good words. The object prompts user entry of a pronunciation instruction for each word within the text string for which a pronunciation instruction is not available in the data base of known good words.

Further, if the motion video file matches review rules indicating that review is required, the auto rendering object may prompt user review of a motion video file before defining the motion video file in the placement database—as associated advertisement content related to an instance of advertisement content.

In an alternative embodiment, the distribution object may further return instructions for driving the rendering of the associated advertisement content on a client system in response to a mouse hovering over the instance of advertisement content. Applying this alternative embodiment of the above sub-embodiments: i) the audio file associated with an instance of advertisement content would play in response to the user mouse hovering over the instance of advertisement content; ii) the motion video file associated with an instance of advertisement content would play in a motion video window in response to the user mouse hovering over the instance of advertisement content; or iii) the preview image associated with an instance of advertisement content would display in a preview image frame in response to the user mouse hovering over the instance of advertisement content.

In another sub embodiment, the advertisement impression may further comprise one of redirect data and the redirect URL. In yet another sub embodiment, the distribution object may store the redirect data or redirect URL in association with the advertisement impression. In this sub embodiment, the advertisement system further comprises a redirect object receiving redirect requests generated by client systems in response to user interaction with the advertisement impression and, in response to receiving a redirect request, looking up the redirect data associated with an impression identifier received in the redirect request and directing the client system to a URL associated with the redirect data.

For a better understanding of the present invention, together with other and further aspects thereof, reference is made to the following description, taken in conjunction with the accompanying drawings. The scope of the present invention is set forth in the appended claims.

### BRIEF DESCRIPTION OF THE DRAWINGS

FIG. 1 is diagram representing architecture of a system for providing enhanced advertisement content in accordance with one embodiment of the present invention;

FIG. 2a is one exemplary embodiment of an advertisement impression in accordance with the present invention;

FIG. 2b is another exemplary embodiment of an advertisement impression in accordance with the present invention;

FIG. 2c is yet another exemplary embodiment of an advertisement impression in accordance with the present invention;

FIG. 2d is yet another exemplary embodiment of an advertisement impression in accordance with the present invention;

FIGS. 3a and 3b represent exemplary advertisement impression requests in accordance with one embodiment of the present invention;

FIG. 4 is a diagram representing an exemplary sub embodiment of a system for providing enhanced advertisement content in accordance with the present invention;

FIG. 5 is a diagram representing an exemplary sub embodiment of a system for providing enhanced advertisement content in accordance with the present invention;

FIG. 6 is a diagram representing an exemplary sub embodiment of a system for providing enhanced advertisement content in accordance with the present invention;

FIG. 7 is a flow chart representing exemplary operation of an advertisement object in accordance with one embodiment of the present invention;

FIGS. 8a and 8b represent exemplary storage of advertisement data in a placement database in accordance with one embodiment of the present invention;

FIG. 9 is a flow chart representing exemplary operation of one aspect of operation of an auto rendering object in accordance with one embodiment of the present invention;

FIG. 10 is a flow chart representing exemplary operation of one aspect of operation of an auto rendering object in accordance with one embodiment of the present invention;

FIG. 11 is a flow chart representing exemplary operation of one aspect of operation of an auto rendering object in accordance with one embodiment of the present invention; and

FIG. 12 is a flow chart representing exemplary operation of one aspect of operation of an auto rendering object in accordance with one embodiment of the present invention.

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

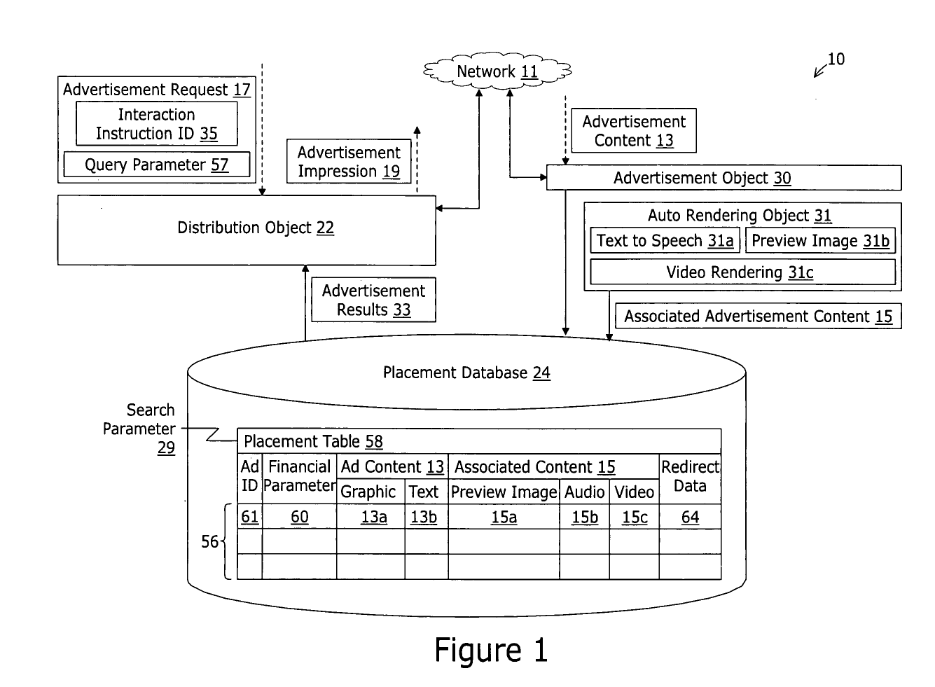

The block diagram of FIG. 1 includes an advertisement system 10 for providing enhanced pay for performance advertisement impressions 19 for presentation in conjunction with media content provided by an affiliate system.

The advertisement system 10 comprises an advertisement object 30, an auto rendering object 31, a distribution object 22, and a placement database 24 coupled to each of the advertisement object 30, the auto rendering object 31, and the distribution object 22.

Each of the advertisement object 30, the auto rendering object 31, the distribution object 22, and other objects discussed within this specification may comprise executable code performing processing steps and those skilled in the art of object oriented programming appreciate that such discreet depiction is to facilitate clear discussion of steps useful for implementing an embodiment of the present invention and is not intended limit the scope of the present invention. An individual skilled in the art of object oriented programming may, with an understand that the present invention, readily select an alternative grouping of functions for performance in accordance with the present invention and without departing from the scope thereof.

The placement database 24 (and other databases discussed within the specification) may comprise related tables of data and the depictions thereof are for purposes of facilitating discussion of exemplary structure for the storage of data useful for implementing an embodiment of the present invention and are not intended limit the scope of the present invention. An individual skilled in the art of database design may, with an understand that the present invention, readily select alternative data storage relationships for performing in accordance with the present invention and without departing from the scope thereof.

Further, those skilled in the art will appreciate that the functions of each of the elements of the advertisement system 10 are readily implemented: i) on a single hardware server; ii) on multiple interconnected hardware servers with elements of the advertisement system 10 implemented on one or more distinct hardware servers; or iii) on multiple interconnected hardware server's with functions of each of elements distributed across each of the multiple hardware servers.

In general, the advertisement object 30 provides a user interface to obtain, from each of a plurality of advertisers, an instance of advertisement content 13. The instance of advertisement content 13 may be stored in a placement table 58 of the placement database 24 that associates with a search parameter 29. The financial parameter 60 and the redirect data 64 are stored therewith.

The search parameter 29 may be a character string useful for associating the instance of advertisement content 13 with a viewer's potential need for the advertiser's products or services—as expressed in a query parameter 57.

More specifically, each instance of advertisement content 13 is linked to one or more search parameters 29 (predefined words which relate to the advertiser's products or services).

When an advertisement impression is to be rendered in response to receiving an advertisement request 17, the advertisement request will include a query parameter 57 which may be: i) a word or phrase that associates with the affiliate media content; or ii) a query string entered by a user into a “search box” interface.

The association between the media content and one or more query parameters 57 may be by: i) means of a web crawler searching contents of the media content and auto-associating the contents with query parameters 57; and/or ii) by the affiliate which generates the media content registering its media content with selected query parameters 57 through an interface of the advertisement object 30.

Search parameters 29 which the same as, are semantically similar to, the query parameter 57 are used to select advertisement content 13 for rendering as an advertisement impression 19. One skilled in the art will recognize that systems could be implemented wherein there is no mapping of query parameters to search parameters is need if the query parameter is used to directly select advertisement content.

The financial parameter 60 provides a basis for determining a charge assessable to the advertiser either: i) in response to presenting the advertisement content 13; and/or ii) in response to the viewer responding to the instance of advertisement content 13 by either going to the advertiser's landing page and/or acquiring products or services from the advertiser.

In exemplary embodiments, the financial parameter 60 may be: i) a bid parameter such as a bid amount associated with the advertisement; and/or ii) information useful for looking up, calculating, or otherwise determining a bid amount or other compensation scheme associated with the instance of advertisement content 13. The financial parameter 60 may be entered through the user interface of the advertisement object 30.

The redirect data 64 may include: i) a redirect URL to which a client system is to be redirected in the event the user selects the advertisement impression 19; and/or ii) information useful for looking up, determining, or requesting (for example requesting from the placement object 24) a redirect URL to which the client system is to be redirected in the event the user selects the advertisement impression 19. The redirect data 64 may be entered through the user interface of the advertisement object 30.

An auto rendering object 31 generates associated advertisement content 15 for storage in the placement database 24 in association with the instance of advertisement content 13. The associated advertisement content 15 relates to the instance of advertisement content 13 and, in three exemplary embodiments, may be: i) a preview image 15a of an advertiser's web landing page to which a client system is directed upon viewer response to an advertisement impression 19; ii) an audio file 15b representing a spoken rendering of a portion of the instance of advertisement content 13; and/or iii) a motion video file representing an animated character performing (animated spoken audio) a portion of the advertisement content.

The distribution object 22 of the system 10 receives advertisement requests 17 and obtains advertisement results 33 from the placement database 24. The advertisement results 33 include one or more selected instances of advertisement content 13 from the placement database 24.

In the exemplary embodiment, the selected instances of advertisement content 13 are: i) those instances that have been associated with a search parameter 29 that semantically corresponds to the query parameter 57; and ii) among those associated instances, those that meet a selection criteria. The selection criteria, for example, may specify selecting those instances of advertisement content 13 having a favorable financial parameter 60, for example the highest bid amount. In another example, the selection criteria may specify selecting, on a rotating basis, one of a plurality of instances of advertisement content 13. U.S. patent application Ser. No. 10/724,546 filed on Aug. 19, 2004 and commonly assigned with the present application describes systems and methods for selecting one of a plurality of instances of advertisement content. The contents of such application is incorporated herein.

The distribution object 22 returns an advertisement impression 19 comprising a combination of the instance of advertisement content 13 and the associated advertisement content 15. The advertisement impression 19 not only includes the combination of the instance of advertisement content 13 and the associated advertisement content 15 but also defines its rendering.

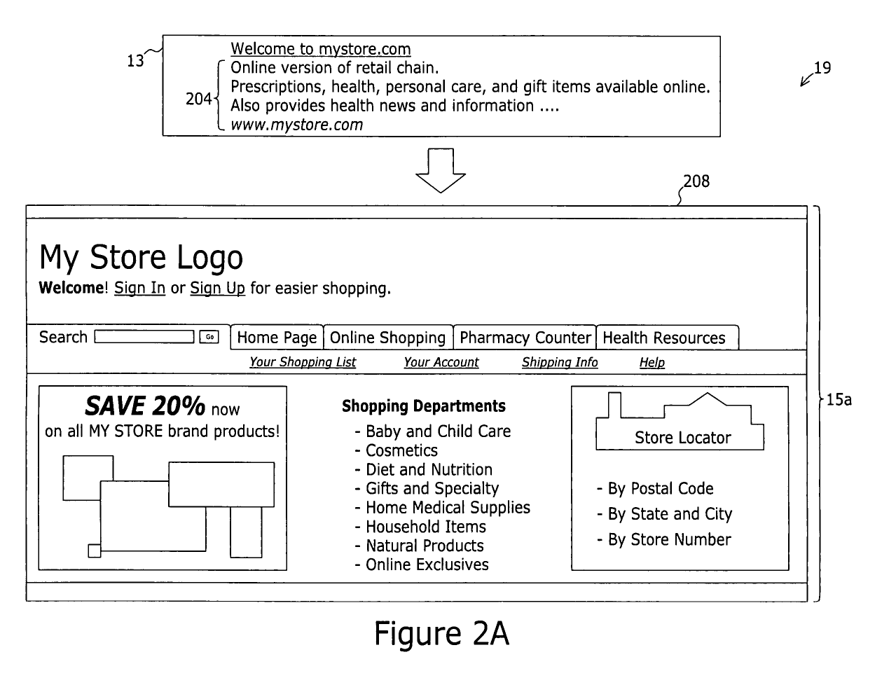

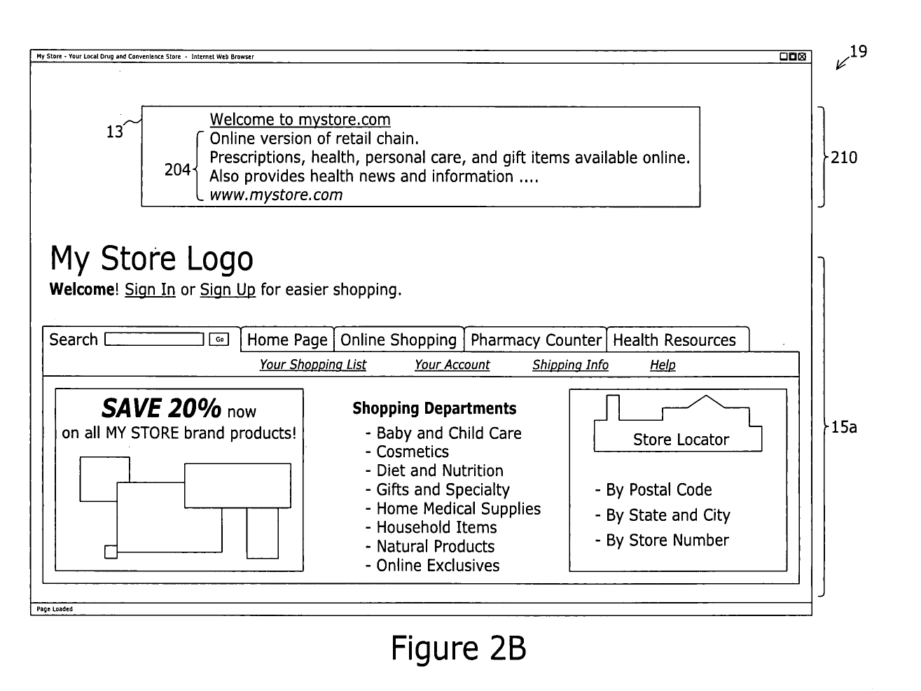

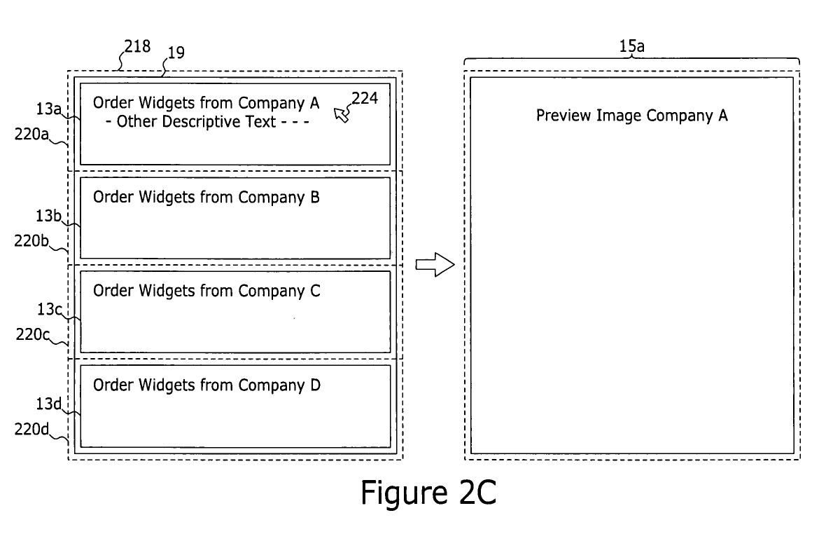

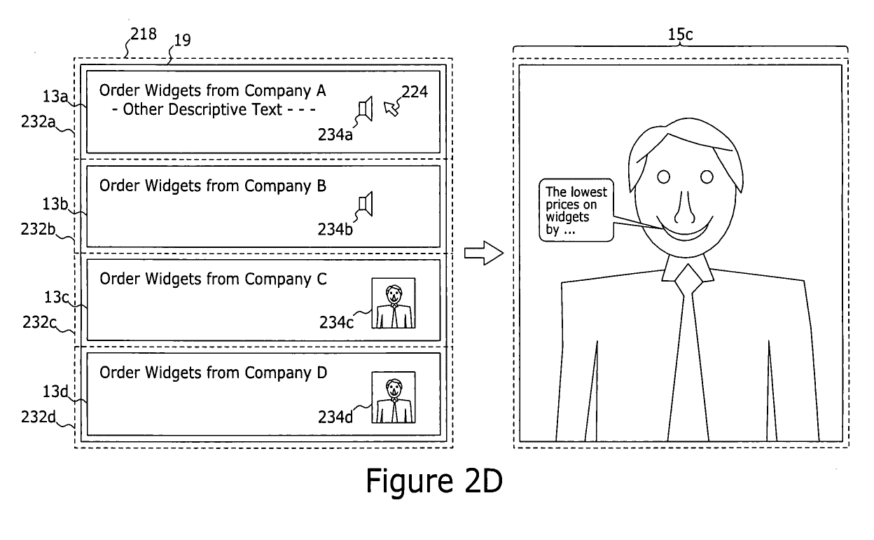

For example, the advertisement impression 19 may include display of an instance of advertisement content 13 as a text or graphic rendering and display of the associated advertisement content 15 comprising a preview image 15a (as a framed window) in response to the user mouse hovering over the advertisement content 13. Such an example is represented by FIG. 2a.

More specifically, in this example, the instance of advertisement content is a text rendering displayed on a client system. The advertisement content 13 includes both a brief description of available products 204 which, if clicked by the user, would initiate direction of the client system to the advertiser's web site landing page. Further, the entire region in which the instance of advertisement content 13 is displayed may be hover active. When the user mouse hovers over the instance of advertisement content 13 (e.g. user first interaction), the associated advertisement content (e.g preview image 15a) displays in a image window 208. The image window 208 may be in any position within the display including adjacent to the instance of advertisement content 13 or over (thereby displacing) the instance of advertisement content 13.

The image window 208 may also be click active such that when the user clicks over the preview image 15a (e.g. user second interaction), the client system is directed to the advertiser's web site landing page.

In another example, represented by FIG. 2b, the advertisement impression 19 may include display of an instance of advertisement content 13 as a text or graphic rendering and display of the associated advertisement content 15 comprising a preview image 15a as a graphic rendering positioned adjacent to the advertisement content 13. More specifically, in this example, the instance of advertisement content 13 is a text rendering displayed on a client system. The advertisement content 13 includes both a brief description of available products 204 which, if clicked by the user, would initiate direction of the client system to the advertiser's web site landing page. Further, displayed in conjunction with the instance of advertisement content 13 is the preview image 15a. In this example, the preview image 15a is a relatively static image. The region in which the preview image 15a is rendered may be active such that, if clicked by the user, the client system would be directed to the advertiser's web site landing page.

In another example, represented by FIG. 2c, the advertisement impression 19 may include a plurality of instances of advertisement content 13a-13d, each of which is text or graphic. The advertisement impression 19 may be rendered in conjunction with an image map (or other structure) with multiple active regions 220a-220d—each of which corresponds to one of the plurality of instances of advertisement content 13a-13d.

In this example, if the user clicks on an active zone, 220a for example, the client system 14 would be directed to the landing page of the advertiser corresponding to the instance of advertisement content 13a. If the user mouse hovers 224 on an active zone, 220a for example, a (e.g. user first interaction), a preview image 15a associated with the instance of advertisement content 13a displays.

The preview image 15a may be in any position within the display including adjacent to the display of the advertisement impression 19 or over (thereby displacing) the display of the advertisement impression 19. As the user moves the hovering mouse 224 between the active regions 220a-220d of the image map 218, the preview image 15a changes such that it always reflects the particular preview image 15a that is associated with the advertisement content 13a-13d over which the mouse 224 is hovered.

When the user clicks on the preview image 15a (e.g. user second interaction), the client system 14 is directed to the web landing page of the advertiser with which clicked preview image 15a is associated.

In yet another example, represented by FIG. 2d, the advertisement impression 19 may include a plurality of instances of advertisement content 13a-13d, each of which is text or graphic. The advertisement impression 19 may be rendered in conjunction with an image map with multiple active regions 232a-232d—each of which corresponds to one of the plurality of instanced of advertisement content 13a-13d.

If the user clicks on an active zone, 232a for example, the client system 14 would be directed to the landing page of the advertiser corresponding to the instance of advertisement content 13a.

In this example, each instance of advertisement content for example 13a and 13b, may be rendered with a video icon 234a and 234b respectively. If the user mouse hovers 224 on an active zone, 232a for example, an audio file 15b representing an audio rendering of advertisement content will be rendered through an audio system of the client system.

As the user moves the hovering mouse 224 between the active regions 232a-232d of the image map 218, the audio output changes such that it always reflects audio advertisement content related to the advertisement content 13a-13d over which the mouse 224 is hovered.

Further, an instance of advertisement content, for example 13c and 13d, may be rendered with a video icon 235c and 235d respectively. If the user mouse hovers 224 on an active zone, 232c for example, a motion video file 15c representing an animated character speaking advertisement content will be rendered in a window 209.

The motion video file 15c may be in any position within the display including adjacent to the display of the advertisement impression 19. As the user moves the hovering mouse 224 between the active regions 232c-232d of the image map 218, the rendered motion video file 15c changes such that it always reflects the particular motion video file 15c that is associated with the advertisement content 13c-13d over which the mouse 224 is hovered.

Alternatively, the motion video file 15c may be rendered in generally the same space (in place of), the video icon 234c or 234d.

In general, the advertisement request 17 specifies the query parameter 57 and could specifies a rendering format of the advertisement impression 19 which is compliant with the interaction instructions 20. If a rendering format is not selected or a “null value” is selected, the rendering format may be selected by the distribution object 22.

In the exemplary embodiment, the advertisement request 17 may be an HTTP connection to a specified URL which includes extension identifying the query parameter 57 and one of a plurality of predetermined rendering formats.

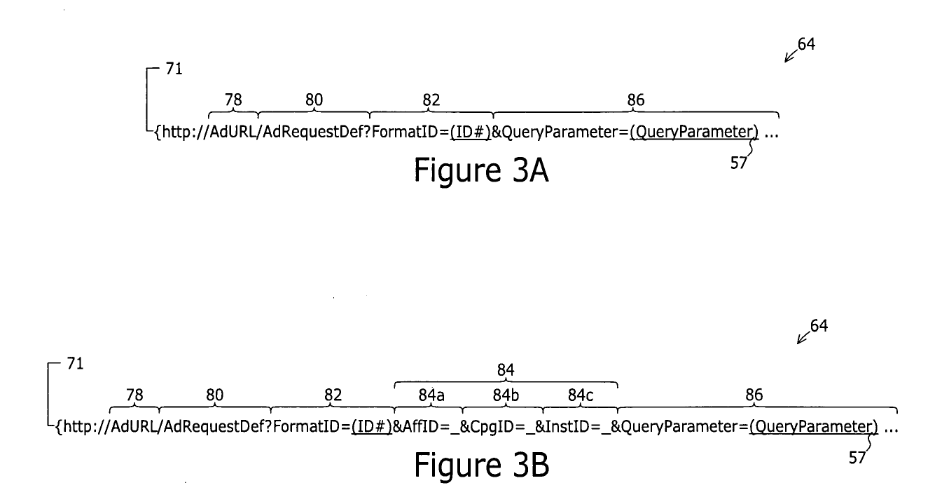

Referring to FIG. 3a, an exemplary advertisement request URL 71 comprising an advertisement request 17 is represented. The advertisement request URL 71 comprises a predetermined core URL 78, a predetermined URL extension 80, a predetermined format identifier 82, and a query parameter identifier 86.

The predetermined core URL 78 is a URL recognizable by DNS servers to facilitate routing of an HTTP connection request using the advertisement request URL 71 to a server operating the distribution object 22. An example of a core URL 78 would be “imagelisting.miva.com”.

The predetermined URL extension 80 is a predetermined character string which serves as an indicator to process the HTTP connection as an advertisement request 17.

The predetermined format identifier 82 is a predetermined value that identifies a format in which the advertisement impression 19 is to be returned. For example, different values of the format identifier 82 different between the various embodiments of advertisement impressions 19 represented in FIGS. 2a through FIG. 2d. It should be appreciated that the value of the format identifier 82 will identify a rendering format for an advertisement impression 19 that associates with the interaction instructions 20 such that the viewer may interact with the advertisement.

The query parameter identifier 86 identifies the query parameter 57 and enables the distribution object 22 to obtain selected advertisement(s) associated with semantically similar search parameters 29 as previously discussed.

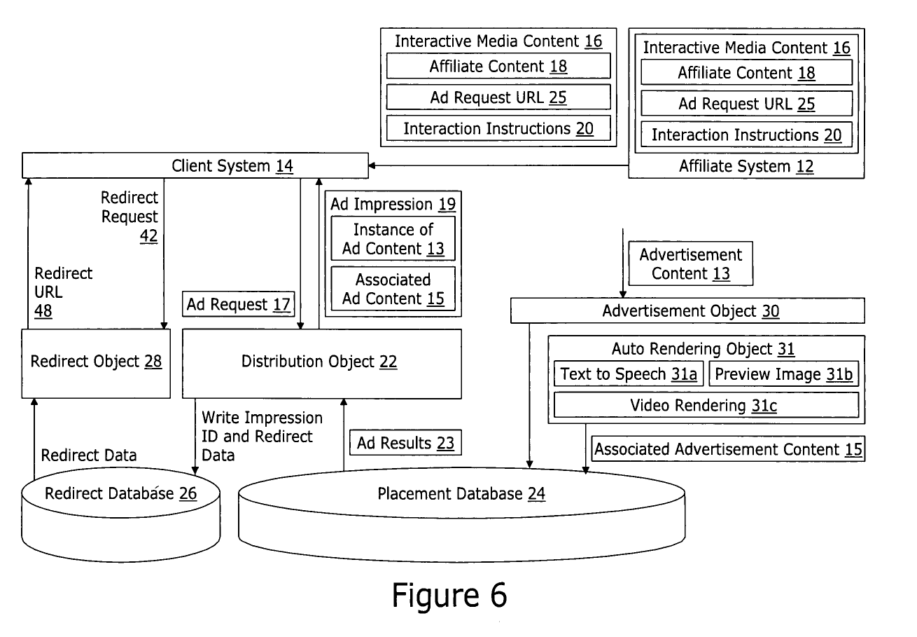

In addition, the advertisement request URL 71 may include other values useful for the practice of various embodiments of the present invention. For example, as shown in FIG. 3b, the advertisement request URL may include an instance identifier 84 identifying values (such as an affiliate ID 82a, a campaign ID 84b, and an instance ID 84c) which distinguish an instance of media content 16 from other instances of the media content. These values are useful in the embodiment of the present invention discussed with respect to FIG. 6 (and in U.S. application Ser. No. 11/236,460) wherein the unique identifier is passed to the distribution object 22 as part of the advertisement request.

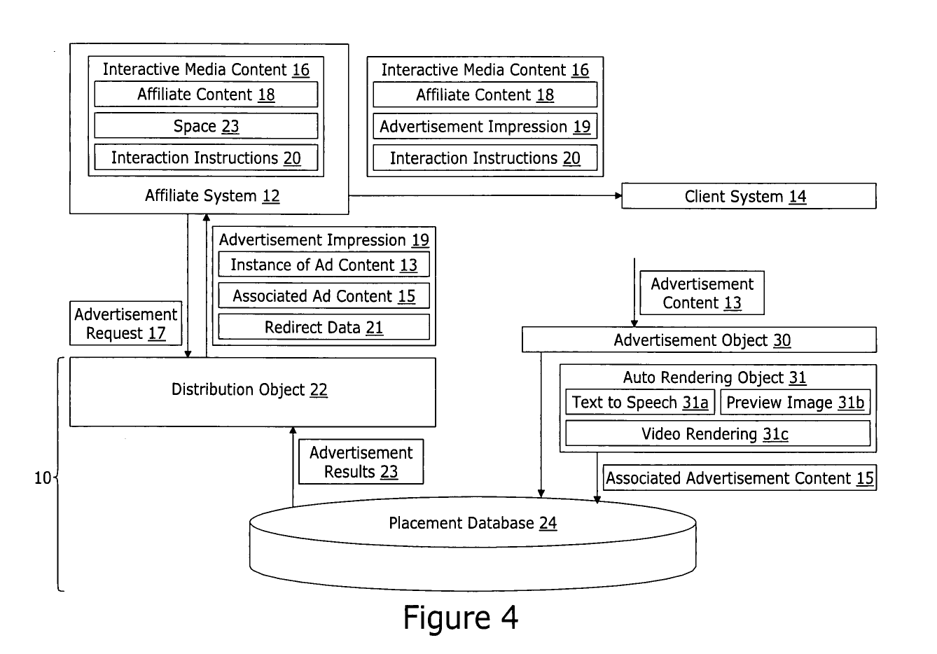

In a first embodiment of the present invention, as represented by FIG. 4, the advertisement request 17 is received from an affiliate system 12 which provides media content 16 (such as web pages) to a client system 14 upon the client system establishing an transport connection to a URL of the affiliate system 12.

In this embodiment, the media content 16, as stored on the affiliate system 12, includes the affiliates content 18, blank space 23 for dynamic embedding of an advertisement impression 19, and interaction instructions 20. As discussed, the interaction instructions 20 manage for managing viewer interaction with the advertisement impression 19 and, upon user response to the adverting impression 19, directing the client system 14 in accordance with redirect data 21.

When a client system 14 establishes a transport connection to a URL of the affiliate system 12, the affiliate system makes the advertisement request 17 to the distribution object 22 and receives the advertisement impression 19 in response thereto.

The advertisement impression 19 includes the instance of advertisement content 13, the associated advertisement content 15, and redirect data 21 identifying a URL to which the client system 14 is to be directed upon viewer response to the advertisement impression 19.

The affiliate system 12 embeds the advertisement impression 19 within the media content 16 (such that it is displayed in the space 23) and provides the media content 16 to the client system 14.

When the viewer, using the client system 14, responds to the advertisement impression 19, the interaction instructions 20 provide for the client system to be directed to the URL determined in accordance with the redirect data 21.

In one embodiment, the URL may be the advertiser's landing page. However such a system would require that the advertiser perform response tracking. In another embodiment, the URL may be associated with the system 10, which in turn not only tracks responses but further redirects the client system 14 to the advertiser's landing page.

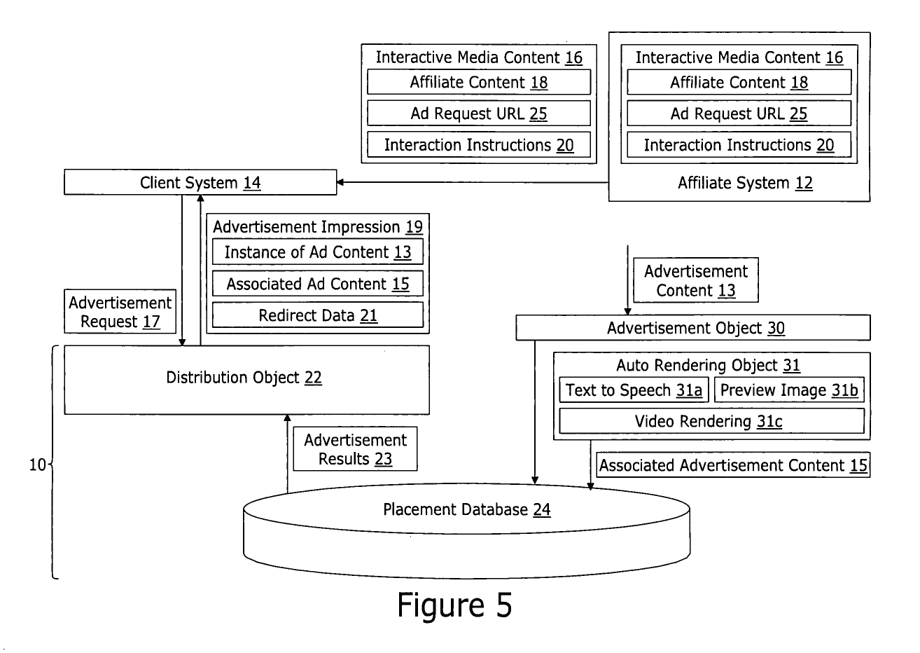

In a second embodiment of the present invention, as represented by FIG. 5, the advertisement request 17 is received from the client system 14 upon the media content 16 being opened by the clients system 14.

In this embodiment, the media content 16, as stored on the affiliate system 12, includes the affiliate content 18, an advertisement request URL 25, and interaction instructions 20. Again, the interaction instructions 20 manage viewer interaction with an advertisement impression 19 and, upon user response to the adverting impression 19, direct a client system 14 in accordance with redirect data 21.

When a client system 14 establishes a transport connection to a URL of the affiliate system 12, the affiliate system 12 provides the media content 16. Upon loading the media content 16, the client system makes an advertisement request 17 to the distribution object 22 and receives the advertisement impression 19 in response thereto —for rendering within the media content 16.

Again, the advertisement impression 19 includes the instance of advertisement content 13, the associated advertisement content 15, and redirect data 21 identifying a URL to which the client system 14 is to be directed upon viewer response to the advertisement impression 19.

When the viewer, using the client system 14, responds to the advertisement impression 19, the interaction instructions 20 provide for the client system to be directed to the URL determined in accordance with the redirect data 21.

Again, in one embodiment, the URL may be the advertiser's landing page and, in another embodiment, the URL may be associated with the system 10, which in turn not only tracks responses but further redirects the client system 14 to the advertiser's landing page.

In a third embodiment of the present invention, as represented by FIG. 6, the advertisement request 17 is received from the client system 14 upon the media content 16 being opened by the client system 14.

Like the second embodiment, the media content 16, as stored on the affiliate system 12, includes the affiliates content 18, an advertisement request URL 25, and interaction instructions 20 for managing viewer interaction with the advertisement impression 19.

In more detail, when a client system 14 loads the media content 16, the client system 14 makes an advertisement request 17 to the distribution object 22 and receives the advertisement impression 19 in response thereto—for rendering within the media content 16.

In this embodiment, the interaction instructions 20, upon user response to the advertisement impression 19, initiate a redirect a redirect request 42 to a redirect object 28 of the advertisement system 10.

The distribution object 22 stores, in a redirect database 26, redirect data in association with in identification of the advertisement impression 19. The identification of the advertisement impression 19 may be a unique ID value generated by the distribution object 22 at the time the advertisement impression 19 is generated or may be a unique ID value associated with a particular instance of the media content 16 which is provided to the distribution object 22 as part of the advertisement request 17.

When the client system 14 makes a redirect request 42, the redirect request 42 will include the identification of the advertisement impression. The redirect object 28 will look up the redirect data stored in association with the identification in the redirect database 26 and return the redirect URL 48 to the client system.

A more detailed discussion of operation of this third embodiment is described in U.S. patent application Ser. No. 11/236,460 filed on Sep. 27, 2005, which is assigned to the same assignee as the present invention. The contents of U.S. patent application Ser. No. 11/236,460 is hereby incorporated into this application by reference.

Advertisement Object

Returning to FIG. 1, the advertisement object 30 provides a user interface to obtain, from each of a plurality of advertisers, an instance of advertisement content 13 and an association between the instance of advertisement content 13 and a financial parameter 60, one or more search parameters 29, and redirect data 64. The advertiser typically accesses the advertisement object 30 via a secure HTTP connection over a network 11 such as the Internet and the advertisement object 30 may provide the interface as web pages to the user.

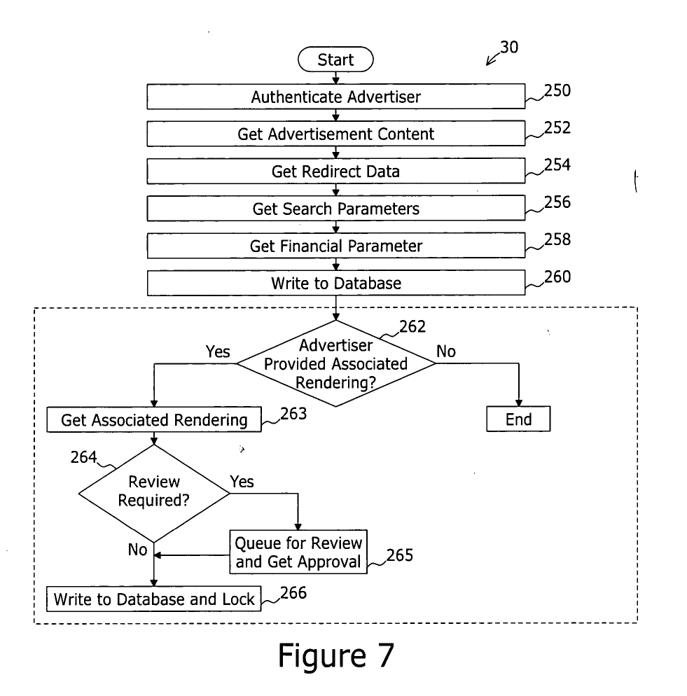

The flow chart of FIG. 7 represents exemplary operation of such an embodiment of the advertisement object 30. Step 250 represents authenticating the advertiser. After authenticating the user, the advertisement object 30 may operate a menu driven application for providing web pages and receiving responses which provide for: i) uploading the advertisement content 13 at step 252, ii) obtaining redirect data 64 for directing a response to the advertisement to the advertiser at step 254—for example a URL to a landing page of the advertiser's web site; iii) obtaining the advertiser selected search parameters 29 to associated with the instance of advertisement at step 256, and iv) obtaining the financial parameter 60 (such as the bid amount) that the advertiser associates with the instances of advertisement content and the search parameter.

Step 260 represents storing the instance of advertisement content 13 along with its associated financial parameter 60, its associated search parameters 29, and its associated redirect data 64 in the placement database 24.

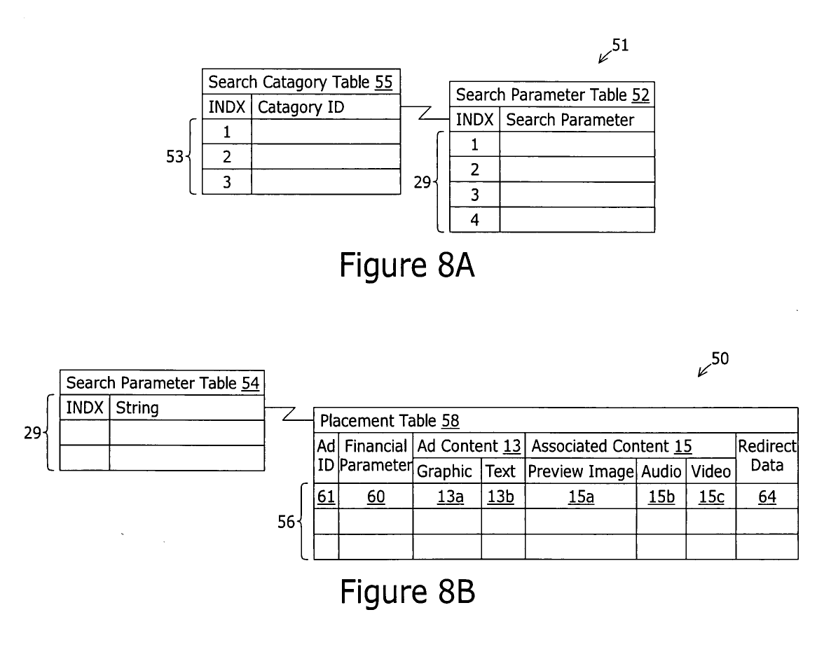

The tables of FIG. 8a and FIG. 8b represent an exemplary structure for organization of the placement database 24.

Each query parameter 57 may be semantically similar to a search parameter 29 or a category ID 55 representing a plurality of predetermined search parameters 29. Turning briefly to FIG. 8a, an exemplary table structure 51 represents organization of predetermined search categories 53. Each search category 53 may be an alpha numeric value which is indexed in a search category table 55. Associated with each search category 53 are a plurality of search parameters 29—which may be stored in a search parameter table 52.

Turning briefly to FIG. 8b, an exemplary table structure 50 represents organization of the predetermined search parameters 29. Within the exemplary table structure 50, each search parameter 29 is indexed in a search parameter table 54. Associated with each search parameter 29 is placement information 56—which may be stored in a placement table 58. The placement information 56 includes, for each advertiser that elected to established a financial parameter (such as a bid) for the search word 52, the then current financial parameter 60, an advertisement identifier 61, the instance of advertisement content 13, associated advertisement content 15, and a redirect URL 64. As discussed, the instance of advertisement content 13 may comprise different rendering formats such as a graphic rendering 13a or a text rendering 13b. Similarly, the associated advertisement content 15 may be in different rendering formats such as an audio rendering 15a and a preview image rendering 15b.

Returning to the flow chart of FIG. 7, step 262 represents determining whether the advertiser will provide associated advertisement content 15. If “No”, the operations of the advertisement object are finished and the associated rendering content 15 may be generated by the auto rendering object 31. If “Yes”, steps 263 through 266 are repeated for each instance of associated advertisement content 15 to be uploaded from the advertiser or rendered through the advertiser's connection to the advertisement object 30. For example, an advertiser could upload an audio file as associated advertisement content 15 or the advertisements object 30 could prompt the advertiser to speak the associated advertisement content into a microphone that links a digital representation therefore to the advertisement object 30. Step 263 represent obtaining the instance of associated advertisement content 15 (which may be a preview image 15a, audio rendering 15b, a video rendering 15c, or other). Step 264 represents determining whether human review is necessary. More specifically, step 264 may include comparing the associated advertisement content with review rules designed for calling attention to associated advertisement content 15 that may not appropriately render. For example, review rules can be based on file size and/or compression format.

If review is not necessary, at step 266 the associated advertisement content 15 is written to the database and locked—to prevent overwriting with auto-rendered associated advertisement content. If review is required, the associated advertisement content 15 is queued for review and approval is obtained at step 265 before being written to the database and locked at step 166.

Auto Rendering Object

As discussed, the auto rendering object 31 generates associated advertisement content 15 for storage in the placement database 24 in association with the instance of advertisement content 13. The associated advertisement content 15 relates to the instance of advertisement content 13 and, in three exemplary embodiments, may be: i) a preview image 15a of a web landing page to which a client system is directed upon viewer response to the instance of advertisement content (or viewer response to the associated advertisement content 15); ii) an audio file 15b representing a spoken rendering of a portion of the instance of advertisement content; and/or iii) a motion video file 15c representing an animated character speaking a portion of the instance of advertisement content.

Certain functions of the auto rendering object 31 may be launched by the advertisement object 30 or may be launched based on periodically updating the records of associated content 15 within the placement database 24.

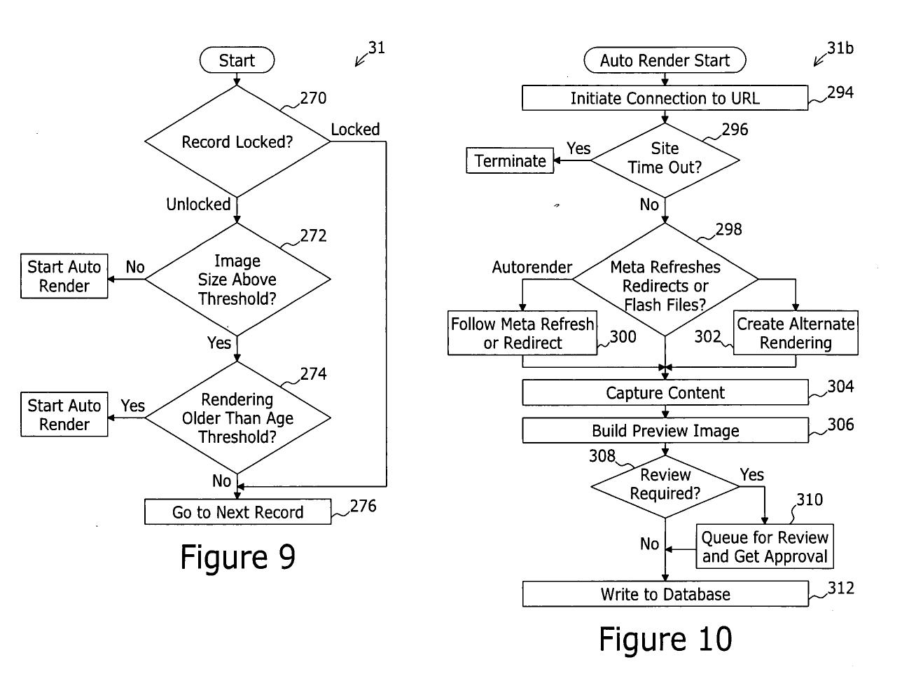

The flow chart of FIG. 9 represents an aspect of operation of the auto rendering object 31 for periodically updating instances of associated advertisement content 15 which are auto rendered preview images 15a. In general the auto rendering object 31 periodically “steps through” all records of the placement table 58 for potentially updating the preview image associated with each advertisement. The steps of the flow chart of FIG. 9 are performed for each record.

Step 270 represents determining whether the record is locked. Locked records are not updated and the object 31 advances to the next record. An example of locked records are those submitted by the advertisers. If the record is unlocked, step 272 represented determining whether the image has a size above a predetermined threshold (for example 8K). If the image has a size below the threshold size, auto rendering is launched independent of how long ago the image was last auto-rendered. If the image has a size larger than the threshold size, then the auto rendering is only performed if the image is older than an age threshold as determined at step 274.

An aspect of operation of the auto-rendering object comprises invoking a preview image rendering object 31b for auto rendering of a preview image 15a. Such operation is represented by FIG. 10. Referring to FIG. 10, in conjunction with FIG. 1, step 294 represents obtaining the redirect data 64 from the placement table 58 and initiating a connection to the advertiser's landing page.

Step 296 represents a determination if the connection request has timed out. If it has, the operation terminates.

Step 298 represents determining whether the landing page includes such features as meta refresh, auto redirects, or active content such as Flash. If the page includes meta refresh or auto redirects, the refresh and/or redirects are followed at step 300. If the page includes active content, a delay is introduced at step 302 to provide for the active content to stabilize (e.g for the Flash to complete).

Step 304 represents capturing the content of the advertiser's landing page (after following meta refresh, following auto redirects, and waiting for active content to stabilize). The capture may use traditional “screen scrapping” techniques.

Step 306 represents building the captured content as a preview image for storage in the placement database 24.

After auto rendering the preview image 15a, it may not be stored directly into the placement database 24. There is sufficient opportunity in the auto-rendering process to introduce unwanted content. Therefore, step 308 represents determining whether human review is necessary. More specifically, step 308 may include comparing the auto-rendered preview image 15a with review rules designed for calling attention to a preview image 15a that may not appropriately render. For example, review rules can be based on file size.

If review is not necessary, at step 312, the preview image 15a is written to the database. If review is required, the preview image 15a is queued for review and approval is obtained at step 310 before being written to the database at step 312.

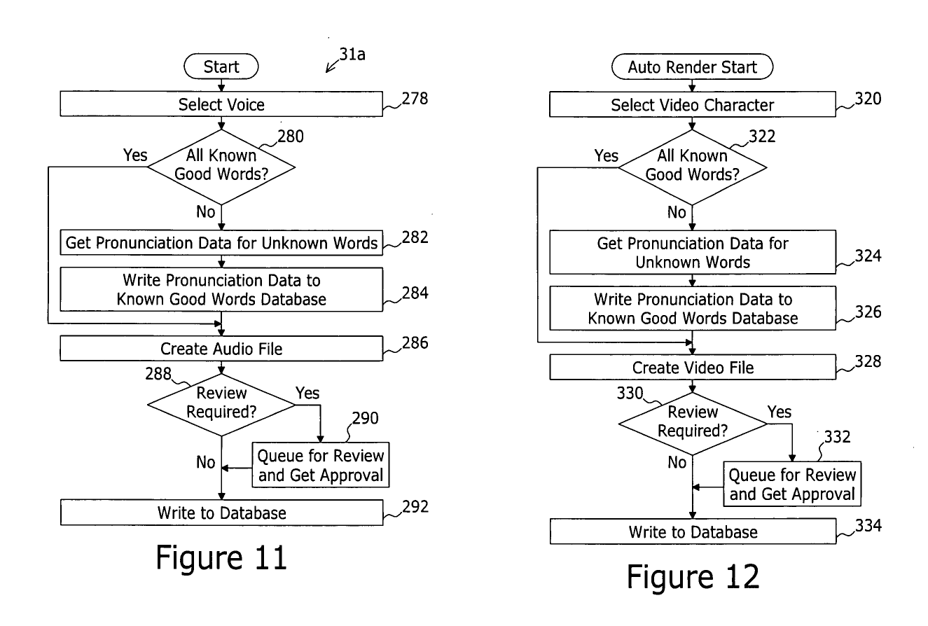

An aspect of operation of the auto-rendering object 31 for auto rendering of an audio file 15b is represented by FIG. 11. In this aspect the audio rendering object 31 invokes operation of a text to speech object 31a to generate a spoken rendering of the instance of advertisement content 13.

Step 278 represents selecting a one of a plurality of voices to use for generating the spoken rendering. The selection of a voice may be based on any of advertisement content, past performance results using the selected voice, or other parameters.

If all words that are to be auto-rendered are known good words (e.g. a pronunciation exists in a known good words database), a text to speech system generates the spoken rendering at step 286.

If the text includes words not in the database, steps 282 and 284 are performed which include generating a user interface to obtain a correct pronunciation and writing the correct pronunciation of the word to the known good words database. Then, at step 286 the text to speech system generated the spoken rendering.

Step 288 represents determining whether human review is necessary. More specifically, step 288 may include comparing the auto-rendered audio file 15b with review rules designed for calling attention to an audio file 15b that may not appropriately rendered. For example, review rules can be based on file size, inclusion of words with multiple pronunciations—for example read (current tense) and read (past tense) or object (the noun) and object (the verb).

If review is not necessary, at step 292, the audio file 15b is written to the database. If review is required, the audio file 15b is queued for review and approval is obtained at step 290 before being written to the database at step 292.

An aspect of operation of the auto-rendering object 31 for auto rendering of a motion video file 15c is represented by FIG. 12. In this aspect the audio rendering object 31 invokes operation of a text to motion video object 31c to generate a motion video representing an animated character speaking a portion of the instance of advertisement content 13.

Step 320 represents selecting a one of a plurality of characters (and the character's corresponding voice) to use for generating the audio/video spoken rendering. The selection of a character may be based on any of advertisement content, past performance results using the selected characters, voice, and/or other parameters.

If all words that are to be auto-rendered are known good words (e.g. a pronunciation and a defined motion for the character's lips exists in a known good words database), a text to speech system generates the spoken rendering at step 322.

If the text includes words not in the database, steps 324 and 226 are performed which include generating a user interface to obtain a correct pronunciation and, where needed, character lip motion and writing the correct pronunciation of the word and again, where needed, the character lip motion to the known good words database. Then, at step 328 the object 31c generates the audio/video rendering of the character performing the advertisement.

Step 330 represents determining whether human review is necessary. More specifically, step 330 may include comparing the auto-rendered motion video file 15c with review rules designed for calling attention to a motion video file 15c that may not appropriately rendered. For example, review rules can be based on file size, inclusion of words with multiple pronunciations—for example read (current tense) and read (past tense) or object (the noun) and object (the verb).

If review is not necessary, at step 330, the motion video file 15c is written to the database. If review is required, the motion video file 15c is queued for review and approval is obtained at step 332 before being written to the database at step 334.

In summary, it should be appreciated that the systems of the present invention provide a system and method for placing pay for performance enhanced advertisement content within affiliate media content—such as web pages and/or distributed email.

Although the invention has been shown and described with respect to certain exemplary embodiments, it is obvious that equivalents and modifications will occur to others skilled in the art upon the reading and understanding of the specification.

As another example, the URL syntax for the advertisement request URL is exemplary only, it is envisioned that other URL syntaxes may be used, for example, all information needed for the practice of the present invention could be incorporated into the URL extension. The present invention includes all such equivalents and modifications, and is limited only by the scope of the following claims.

What is claimed is:

1. An advertisement system for providing enhanced pay for performance advertising in conjunction with content, the system comprising:
an advertisement object for:
defining, in a placement database, an instance of advertisement content; and
defining a financial parameter in the placement database in association with the instance of advertisement content;
defining redirect data in the placement database in association with the instance of advertisement content, the redirect data useful for determining a redirect URL to which a client system is to be directed upon user response to the advertisement content or associated advertisement content;
an auto rendering object for generating the associated advertisement content;
a distribution object receiving advertisement requests and, in response to receiving an advertisement request:
obtaining from the placement database, an instance of advertisement content;
obtaining from the placement database, the associated advertisement content that is associated with the instance of advertisement content in the placement database, and
returning an advertisement impression comprising both the instance of advertisement content and the associated advertisement content.

2. The advertisement system of claim 1, wherein:
the associated advertisement content is an audio rendering of a portion of the instance of advertisement content; and
the auto rendering object includes a text to speech rendering object which, in response to input of a text string portion of the instance of advertisement content, renders a spoken representation of the text string as an audio file.

3. The advertisement system of claim 2, wherein the text to speech rendering object:
includes a database of pronunciation instructions for a plurality of words;
renders a spoken representation of each word in the text string for which the pronunciation instructions are available in a known good word database;
prompts user entry of a pronunciation instruction for each word within the text string for which a pronunciation instructions is not available in the known good word database;
stores each pronunciation instruction provided by user entry in the known good word database.

4. The advertisement system of claim 2, wherein the auto rendering object compares the audio file to review rules and prompts user review of audio file before defining the audio file in the placement database as associated advertisement content if the audio file matches review rules indicating that user review is required.

5. The advertisement system of claim 1, wherein:
the associated advertisement content is a pre-view image comprising a graphic representation of a portion of the content obtained in response to linking to the redirect URL; and
the auto rendering object includes a preview image rendering object which captures content from a web page obtained in response to linking to the redirect URL and renders such captured content as a preview image file.

6. The advertisement system of claims 5, wherein the preview image rendering object captures content from the web page by capturing an image of a rendering of the web page including:
determining whether redirects are received in response to establishing a connection to the URL to which the client is directed upon user responding to the advertisement;
establishing a connection to the redirect to a redirect web page and capturing an image of a rendering of the redirect web page.

7. The advertisement system of claims 5, wherein the preview image rendering object captures content from the web page by capturing an image of a rendering of the web page including:
determining whether the web page includes a display of dynamic content; and
capturing an image of a rendering of the web page after initiating a delay to enable the dynamic content to stabilize.

8. The advertisement system of claim 5, wherein the auto rendering object compares the preview image to review rules and prompts user review of preview image before defining the preview image in the placement database as associated advertisement content if the preview image matches review rules indicating that user review is required.

9. The advertisement system of claim 1, wherein:
the associated advertisement content is a motion video rendering of a portion of the instance of advertisement content; and
the auto rendering object includes a text to motion video rendering object which, in response to input of a text string portion of the instance of advertisement content, renders motion video of a character speaking the text string as a compressed video file.

10. The advertisement system of claim 9, wherein the text to motion video rendering object:
includes a database of pronunciation instructions for a plurality of words;
renders an audio representation of each word in the text string for which the pronunciation instructions are available in a known good word database;
prompts user entry of a pronunciation instruction for each word within the text string for which a pronunciation instructions is not available in the known good word database;
stores each pronunciation instruction provided by user entry in the known good word database.

11. The advertisement system of claim 9, wherein the auto rendering object compares the motion video file to review rules and prompts user review of the motion video file before defining the motion video file in the placement database as associated advertisement content if the motion video file matches review rules indicating that user review is required.

12. The advertisement system of claim 1, wherein the distribution object further returns instructions for driving the rendering of the associated advertisement content on a client system in response to mouse hover over the instance of advertisement content.

13. The advertisement system of claim 12, wherein:
the associated advertisement content is an audio rendering of a portion of the instance of advertisement content; and
the auto rendering object includes a text to speech rendering object which, in response to input of a text string portion of the instance of advertisement content, renders a spoken representation of the text string as an audio file.

14. The advertisement system of claim 13, wherein the text to speech rendering object:
includes a database of pronunciation instructions for a plurality of words;
renders a spoken representation of each word in the text string for which the pronunciation instructions are available in a known good word database;
prompts user entry of a pronunciation instruction for each word within the text string for which a pronunciation instructions is not available in the known good word database;
stores each pronunciation instruction provided by user entry in the known good word database.

15. The advertisement system of claim 13, wherein the auto rendering object compares the audio file to review rules and prompts user review of audio file before defining the audio file in the placement database as associated advertisement content if the audio file matches review rules indicating that user review is required.

16. The advertisement system of claim 12, wherein:
the associated advertisement content is a pre-view image comprising a graphic representation of a portion of the content obtained in response to linking to the redirect URL; and
the auto rendering object includes a preview image rendering object which captures content from a web page obtained in response to linking to the redirect URL and renders such captured content as a preview image file.

17. The advertisement system of claims 16, wherein the preview image rendering object captures content from the web page by capturing an image of a rendering of the web page including:
determining whether redirects are received in response to establishing a connection to the URL to which the client is directed upon user responding to the advertisement;
establishing a connection to the redirect to a redirect web page and capturing an image of a rendering of the redirect web page.

18. The advertisement system of claims 16, wherein the preview image rendering object captures content from the web page by capturing an image of a rendering of the web page including:
determining whether the web page includes a display of dynamic content; and
capturing an image of a rendering of the web page after initiating a delay to enable the dynamic content to stabilize.

19. The advertisement system of claim 16, wherein the auto rendering object compares the preview image to review rules and prompts user review of preview image before defining the preview image in the placement database as associated advertisement content if the preview image matches review rules indicating that user review is required.

20. The advertisement system of claim 12, wherein:
the associated advertisement content is a motion video rendering of a portion of the instance of advertisement content; and
the auto rendering object includes a text to motion video rendering object which, in response to input of a text string portion of the instance of advertisement content, renders motion video of a character speaking the text string as a compressed video file.

21. The advertisement system of claim 20, wherein the text to motion video rendering object:
includes a database of pronunciation instructions for a plurality of words;
renders an audio representation of each word in the text string for which the pronunciation instructions are available in a known good word database;
prompts User entry of a pronunciation instruction for each word within the text string for which a pronunciation instructions is not available in the known good word database;
stores each pronunciation instruction provided by user entry in the known good word database.

22. The advertisement system of claim 20, wherein the auto rendering object compares the motion video file to review rules and prompts user review of the motion video file before defining the motion video file in the placement database as associated advertisement content if the motion video file matches review rules indicating that user review is required.

23. A method for operating an advertisement system for providing enhanced pay for performance advertising in conjunction with content, the method comprising:
defining, in a placement database, an instance of advertisement content; and
defining a financial parameter in the placement database in association with the instance of advertisement content;
defining redirect data in the placement database in association with the instance of advertisement content, the redirect data useful for determining a redirect URL to which a client system is to be directed upon user response to the advertisement content or associated advertisement content;
generating the associated advertisement content;
receiving an advertisement requests and, in response to receiving an advertisement request:
obtaining from the placement database, an instance of advertisement content;
obtaining from the placement database, the associated advertisement content that is associated with the instance of advertisement content in the placement database, and
returning an advertisement impression comprising both the instance of advertisement content and the associated advertisement content.

24. The method of claim 23, wherein:
the associated advertisement content is an audio rendering of a portion of the instance of advertisement content; and
the method comprises operating a text to speech rendering object which, in response to input of a text string portion of the instance of advertisement content, renders a spoken representation of the text string as an audio file.

25. The method of claim 24, wherein the text to speech rendering object:
includes a database of pronunciation instructions for a plurality of words;
renders a spoken representation of each word in the text string for which the pronunciation instructions are available in a known good word database;
prompts user entry of a pronunciation instruction for each word within the text string for which a pronunciation instructions is not available in the known good word database;
stores each pronunciation instruction provided by user entry in the known good word database.

26. The method of claim 24, further comprising:
comparing the audio file to review rules; and
prompting user review of audio file before defining the audio file in the placement database as associated advertisement content if the audio file matches review rules indicating that user review is required.

27. The advertisement system of claim 23, wherein:
the associated advertisement content is a pre-view image comprising a graphic representation of a portion of the content obtained in response to linking to the redirect URL; and
the method comprises operating a preview image rendering object which captures content from a web page obtained in response to linking to the redirect URL and renders such captured content as a preview image file.

28. The method of claims 27, wherein the preview image rendering object captures content from the web page by capturing an image of a rendering of the web page including:
determining whether redirects are received in response to establishing a connection to the URL to which the client is directed upon user responding to the advertisement;
establishing a connection to the redirect to a redirect web page and capturing an image of a rendering of the redirect web page.

29. The method of claims 27, wherein the preview image rendering object captures content from the web page by capturing an image of a rendering of the web page including:
determining whether the web page includes a display of dynamic content; and
capturing an image of a rendering of the web page after initiating a delay to enable the dynamic content to stabilize.

30. The method of claim 27, further comprising:
comparing the preview image to review rules; and
prompting user review of preview image before defining the preview image in the placement database as associated advertisement content if the preview image matches review rules indicating that user review is required.

31. The method of claim 23, wherein:
the associated advertisement content is a motion video rendering of a portion of the instance of advertisement content; and
the method comprises operating a text to motion video rendering object which, in response to input of a text string portion of the instance of advertisement content, renders motion video of a character speaking the text string as a compressed video file.

32. The method of claim 31, wherein the text to motion video rendering object:
includes a database of pronunciation instructions for a plurality of words;
renders an audio representation of each word in the text string for which the pronunciation instructions are available in a known good word database;
prompts user entry of a pronunciation instruction for each word within the text string for which a pronunciation instructions is not available in the known good word database;
stores each pronunciation instruction provided by user entry in the known good word database.

33. The method of claim 31, further comprising:
comparing the motion video file to review rules; and
prompting user review of the motion video file before defining the motion video file in the placement database as associated advertisement content if the motion video file matches review rules indicating that user review is required.

34. The method of claim 23, further comprising, in response to receiving an advertisement request; returning, in conjunction with the advertisement impression, instructions for driving the rendering of the associated advertisement content on a client system in response to mouse hover over the instance of advertisement content.

35. The method of claim 34, wherein:
the associated advertisement content is an audio rendering of a portion of the instance of advertisement content; and
the method comprises operating a text to speech rendering object which, in response to input of a text string portion of the instance of advertisement content, renders a spoken representation of the text string as an audio file.

36. The method of claim 35, wherein the text to speech rendering object:
includes a database of pronunciation instructions for a plurality of words;
renders a spoken representation of each word in the text string for which the pronunciation instructions are available in a known good word database;
prompts user entry of a pronunciation instruction for each word within the text string for which a pronunciation instructions is not available in the known good word database;
stores each pronunciation instruction provided by user entry in the known good word database.

37. The method of claim 35, further comprising:
comparing the audio file to review rules; and
prompting user review of audio file before defining the audio file in the placement database as associated advertisement content if the audio file matches review rules indicating that user review is required.

38. The method of claim 34, wherein:
the associated advertisement content is a pre-view image comprising a graphic representation of a portion of the content obtained in response to linking to the redirect URL; and
the method comprises operating a preview image rendering object which captures content from a web page obtained in response to linking to the redirect URL and renders such captured content as a preview image file.

39. The method of claims 38, wherein the preview image rendering object captures content from the web page by capturing an image of a rendering of the web page including:
determining whether redirects are received in response to establishing a connection to the URL to which the client is directed upon user responding to the advertisement;
establishing a connection to the redirect to a redirect web page and capturing an image of a rendering of the redirect web page.

40. The method of claims 38, wherein the preview image rendering object captures content from the web page by capturing an image of a rendering of the web page including:
determining whether the web page includes a display of dynamic content; and
capturing an image of a rendering of the web page after initiating a delay to enable the dynamic content to stabilize.

41. The method of claim 38, further comprising:
comparing the preview image to review rules; and
prompting user review of preview image before defining the preview image in the placement database as associated advertisement content if the preview image matches review rules indicating that user review is required.

42. The method of claim 34, wherein:
the associated advertisement content is a motion video rendering of a portion of the instance of advertisement content; and
the method comprises operating a text to motion video rendering object which, in response to input of a text string portion of the instance of advertisement content, renders motion video of a character speaking the text string as a compressed video file.

43. The method of claim 42, wherein the text to motion video rendering object:
includes a database of pronunciation instructions for a plurality of words;
renders an audio representation of each word in the text string for which the pronunciation instructions are available in a known good word database;
prompts user entry of a pronunciation instruction for each word within the text string for which a pronunciation instructions is not available in the known good word database;
stores each pronunciation instruction provided by user entry in the known good word database.

44. The method of claim 42, further comprising:
comparing the motion video file to review rules; and
and prompting user review of the motion video file before defining the motion video file in the placement database as associated advertisement content if the motion video file matches review rules indicating that user review is required.

45. An advertisement system for providing enhanced pay for performance advertising in conjunction with content, the system comprising:
an advertisement object for:
defining, in a placement database, an instance of advertisement content; and
defining a financial parameter in the placement database in association with the instance of advertisement content;
defining redirect data in the placement database in association with the instance of advertisement content, the redirect data useful for determining a redirect URL to which a client system is to be directed upon user response to the advertisement content or associated advertisement content;
an auto rendering object for generating the associated advertisement content;
the associated advertisement content being associated advertisement content selected from a group of associated advertisement content consisting of:
an alternative rendering of the instance of advertisement content; and
an alternative rendering of content obtained in response to linking to the redirect URL;
a distribution object receiving advertisement requests and, in response to receiving an advertisement request:
obtaining from the placement database, an instance of advertisement content;
obtaining from the placement database, the associated advertisement content that is associated with the instance of advertisement content in the placement database, and
returning an advertisement impression comprising both the instance of advertisement content and the associated advertisement content.
